(19) United States
(12) Patent Application Publication
(10) Pub. No.: US 2026/0112331 A1
(43) Pub. Date: Apr. 23, 2026

(54) DRIVING METHOD OF DISPLAY DEVICE AND DISPLAY DEVICE

(71) Applicant: HKC CORPORATION LIMITED, Shenzhen (CN)

(72) Inventors: Bin Qiu, Shenzhen (CN); Pei Xu, Shenzhen (CN)

(21) Appl. No.: 19/342,715

(22) Filed: Sep. 29, 2025

(30) Foreign Application Priority Data
Oct. 17, 2024 (CN) 202411452957.X

(51) Int. Cl. G09G 3/36

(52) U.S. Cl. CPC G09G 3/3688; G09G 2310/08; G09G 2320/0271; G09G 2330/021; G09G 2360/16

(57) ABSTRACT

A driving method for a display device and a display device are disclosed. The driving method includes: determining, based on a voltage change value and a resistance value whether to perform grading adjustment on a target data voltage pre-input to a data line; adjusting, according to predetermined grading rules, a data voltage on the data line by grading when the voltage change is greater than or equal to a predetermined value, and inputting the graded data voltages to the data lines respectively to drive the display panel; outputting, the target data voltage pre-input directly to the data line to drive the display panel when the voltage change value is less than the preset value.

### CROSS-REFERENCE TO RELATED APPLICATIONS

The present application claims the priority and benefit of Chinese patent application number 202411452957X, titled “Driving Method of Display Device and Display Device” and filed on Oct. 17, 2024 with China National Intellectual Property Administration, the entire contents of which are incorporated herein by reference.

### TECHNICAL FIELD

The present application relates to the field of display technology, and more particularly relates to a driving method of a display device and a display device.

### BACKGROUND

As a flat-panel display device, thin film transistor liquid crystal display (hereinafter referred to as TFT-LCD) is increasingly applied in high-performance display fields due to its characteristics such as small size, low power consumption, no radiation, and relatively low manufacturing cost. When the TFT-LCD performs display, gate lines on the display panel perform progressive scanning row by row to turn on pixel units connected to the gate line of each row, data lines output data signals to the turned-on pixel units to charge the pixel units. The deflection angle of the liquid crystals corresponding to pixel units charged with different amounts of electricity are also different, so that images of different gray levels may be displayed. In order to further reduce the production cost of liquid crystal display products, the existing circuits used for scanning the gate lines often adopt a gate driver on array (hereinafter referred to as GOA) design. This design integrates a thin film transistor (hereinafter referred to as TFT) gate switch circuit on the array substrate of the display panel to form a scanning drive for the display panel. This kind of gate switch circuit integrated on the array substrate using GOA technology is also called a GOA unit or a shift register unit. Since the display device using GOA units eliminates the part of binding the drive circuit, it may reduce the product cost from both the material cost and the manufacturing process aspects.

In addition to the design of GOA for the cost reduction solution of the panel, there is now another solution following a new trend, that is, the glass substrate. Besides being used in cell design of the display panel, the glass substrate also has applications in glass-based backlight design and glass printed circuit board (hereinafter referred to as PCB) design. However, due to the large impedance and the absence of capacitance on the glass substrate, there is a relatively large instantaneous power draw of the power supply voltage, which affects the stability of the ground terminal (hereinafter referred to as GND), and consequently affects the stability of all power supplies and voltages.

### SUMMARY

The objective of the embodiments of the present application is to provide a driving method of a display device and a display device, which may improve the situation where a large load change leads to a large instantaneous power draw of the power supply voltage and a decline in stability.

The present application discloses a driving method of a display device. The display device includes a display panel and a driving module; the driving module includes a timing control board and a glass substrate, the timing control board generates a driving signal and a power supply signal, the driving signal and the power supply signal are respectively output to the display panel through different traces of the glass substrate; the driving method includes:
predicting a voltage change value of a data line inside the display panel;
obtaining a resistance value of at least one of the traces on the glass substrate;
determining, based on the voltage change value and the resistance value, whether to perform grading adjustment on a target data voltage pre-input to the data line; and
adjusting, according to predetermined grading rules, a data voltage on the data line by grading when the voltage change is greater than or equal to a predetermined value, generating graded data voltages, and inputting the graded data voltages to the data lines respectively to drive the display panel; outputting, according to original rules, the target data voltage pre-input directly to the data line to drive the display panel when the voltage change value is less than the preset value.

The present application discloses a display device, the display device includes a display panel and a driving module, the driving module includes a timing control board and a glass substrate, the timing control board outputs a driving signal and a power supply signal to traces on the glass substrate for transmission to the display panel; the display device further comprises a source driver chip, the timing control board comprises a memory and a logic judgment module, the memory stores the resistance value of the traces on the glass substrate and data information, the logic judgment module determines, based on the resistance value of the traces on the glass substrate and the data information, whether to perform grading adjustment on the target data voltage pre-input to the data line, the source driver chip according to the judgment result of the logic judgment module, generates a corresponding data voltage, and outputs the corresponding data voltage to the data line of the display panel for driving, the display device is driven by a driving method described as follows; the driving method includes:
predicting a voltage change value of a data line inside the display panel;
obtaining a resistance value of at least one of the traces on the glass substrate;
determining, based on the voltage change value and the resistance value, whether to perform grading adjustment on a target data voltage pre-input to the data line; and
adjusting, according to predetermined grading rules, a data voltage on the data line by grading when the voltage change is greater than or equal to a predetermined value, generating graded data voltages, and inputting the graded data voltages to the data lines respectively to drive the display panel; outputting, according to original rules, the target data voltage pre-input directly to the data line to drive the display panel when the voltage change value is less than the preset value.

The present application uses a glass substrate as the circuit board for laying traces. The data voltage pre-input to the data line is graded and adjusted, according to the voltage change value of the data line and the resistance value of the traces on the glass substrate. Adjusting, according to predetermined grading rules, a data voltage on the data line by grading when the voltage change is greater than or equal to a predetermined value, generating graded data voltages, and inputting the graded data voltages to the data lines respectively to drive the display panel; outputting, according to original rules, the target data voltage pre-input directly to the data line to drive the display panel when the voltage change value is less than the preset value. This avoids a large pressure difference before and after the data line, which may lead to serious current draw, thus affecting the power supply voltage and causing abnormal gamma voltage levels. Moreover, without the need to additionally set up a current changing circuit or a voltage changing circuit to adjust the power supply voltage, the problem of instantaneous current draw of each voltage source may be compensated. Therefore, the problem of large instantaneous current draw during light to heavy load switching may be solved, and the stability of the power supply and the ground terminal may be maintained.

### BRIEF DESCRIPTION OF DRAWINGS

The accompanying drawings are used to provide a further understanding of the embodiments according to the present application, and constitute a part of the specification. They are used to illustrate the embodiments according to the present application, and explain the principles of the present application in conjunction with the text description. Apparently, the drawings in the following description merely represent some embodiments of the present disclosure, and for those having ordinary skill in the art, other drawings may also be obtained based on these drawings without investing creative efforts. In the drawings:

FIG. 1 is a flowchart of a driving method according to a first embodiment of the present application.

FIG. 2 is an exemplary schematic diagram of the power supply voltage and present signal waveforms of the present application.

FIG. 3 is a flowchart of a driving method according to a second embodiment of the present application.

FIG. 4 is a schematic diagram of the power supply voltage and present signal waveforms before and after improvement of the second embodiment of the present application.

FIG. 5 is a flowchart of a driving method according to a third embodiment of the present application.

FIG. 6 is a flow diagram of a driving method according to a fourth embodiment of the present application.

FIG. 7 is a flow diagram of a driving method according to a fifth embodiment of the present application.

FIG. 8 is a schematic diagram of a display device according to a sixth embodiment of the present application.

### DETAILED DESCRIPTION OF EMBODIMENTS

It should be understood that the terms used herein, the specific structures arrangements, and the functional details disclosed herein are merely representative for describing some specific embodiments, but the present application may be implemented in many alternative forms and should not be construed as being limited to only these embodiments described herein.

The present application will be described in detail below with reference to the accompanying drawings and some optional embodiments.

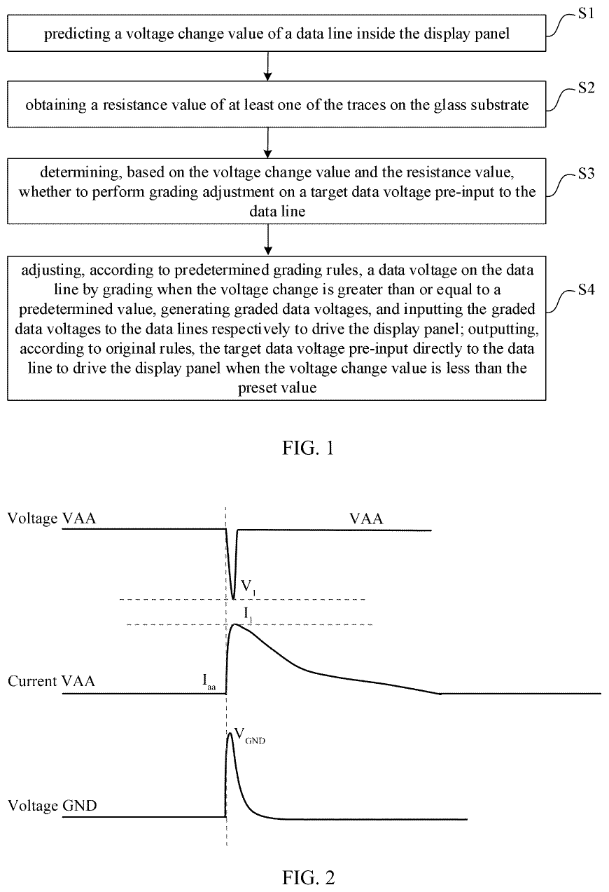

As shown in FIG. 1, as a first embodiment of the present application, to address power voltage instability caused by significant load variations, a driving method for a display device is disclosed, the display device includes a display panel and a driving module, the driving module includes a timing control board and a glass substrate, the timing control board generates a driving signal and a power supply signal, the driving signal and the power supply signal are respectively output to the display panel through different traces of the glass substrate; the driving method includes:
S1: predicting a voltage change value of a data line inside the display panel;
S2: obtaining a resistance value of at least one of the traces on the glass substrate;
S3: determining, based on the voltage change value and the resistance value, whether to perform grading adjustment on a target data voltage pre-input to the data line; and
S4: adjusting, according to predetermined grading rules, a data voltage on the data line by grading when the voltage change is greater than or equal to a predetermined value, generating graded data voltages, and inputting the graded data voltages to the data lines respectively to drive the display panel; outputting, according to original rules, the target data voltage pre-input directly to the data line to drive the display panel when the voltage change value is less than the preset value.

As shown in FIG. 2, which is an actual voltage test diagram of light-load switching to heavy-load when the glass substrate serves as a PCB between a timing control board and a chip-on-film of the display device, three waveform lines in the figure, from top to bottom, represent a power voltage waveform, a power current waveform, and a zero-potential reference point waveform, respectively. Under normal conditions, the power voltage is a stable voltage source waveform, the voltage value is stable at VAA with almost no visible fluctuation. Therefore, this power voltage is usually represented by VAA, a power trace is referred to as a VAA trace, and the resistance of the power trace is represented by Rvaa. At the instant of screen switching, the current required by a backend load suddenly increases. However, a power supply chip is not able to react instantly at this moment. With constant provided power, the power voltage suddenly drops from VAA to V₁ (V₁<VAA), while the power current abruptly reaches I₁ (I₁>Iₐₐ). During the extremely short period before and after this change, power before the change equals power after the change, thus Iₐₐ×VAA≈I₁×V₁. Subsequently, the power supply adjusts its output to restore the power voltage to VAA, with the power current outputting Iₐₐ according to actual demand. Due to this instantaneous current draw and the presence of trace impedance and parasitic inductance in GND, when circuit switches are suddenly opened or closed, internal over voltage occurs. This generates spike current within the circuit over a short duration, causing the voltage value of the zero-potential reference point on the glass PCB to instantaneously rise to VGND. Based on this, the present application first predicts the voltage change value of the data lines in the display panel, according to the difference in the front and back changes of the pixels on the data line, and the voltage change value and the resistance value of the traces on the glass substrate, determines whether to perform graded adjustment on the target data voltage pre-input to the data line. When the voltage change is greater than or equal to a predetermined value, the data voltage on the data line is graded and adjusted according to the preset grading rules. The graded data voltages are generated and then input to the data lines respectively to drive the display panel. That is, the graded adjustment is performed on the basis of the already output data voltage, rather than directly outputting the data voltage of the pre-output value to the data line, thus avoiding a too large pressure difference between the previous and subsequent data voltages. When the voltage change value is less than the preset value, the target data voltage pre-input to the data line is directly output to the data line for driving according to the original rules. There is no need to worry about the occurrence of problems caused by an unstable power supply voltage due to a too large pressure difference, avoiding the problem that excessive fluctuations in the VAA voltage may lead to abnormal gamma voltage levels. The original rule is the rule that the display panel does not adjust the data voltage, and the output is directly sent to the display panel without grading the data voltage.

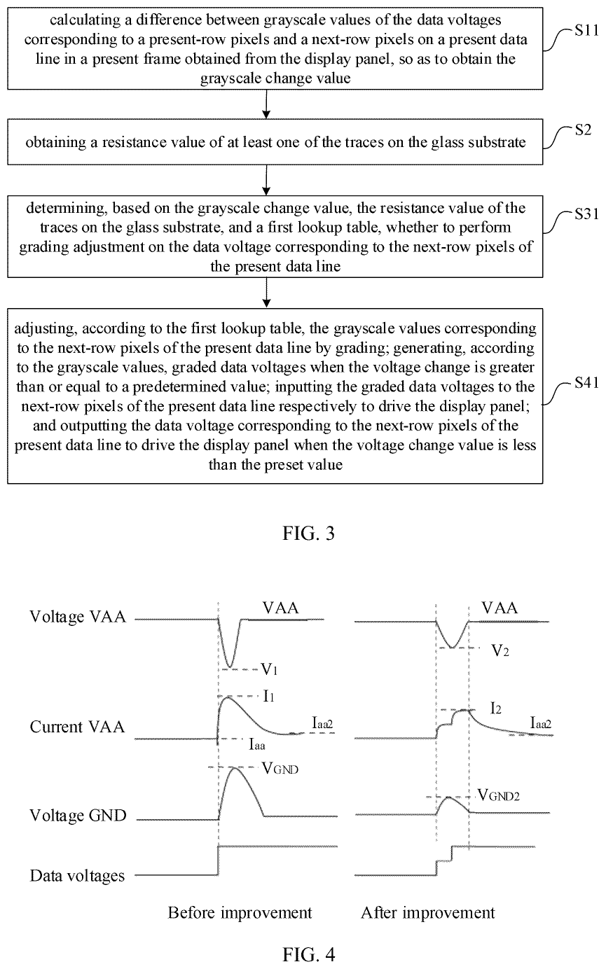

As shown in FIG. 3, as a second embodiment of the present application, it is a further refinement and improvement of the above mentioned first embodiment, the voltage change value includes a grayscale change value, the step S1 includes:
S11: calculating a difference between grayscale values of the data voltages corresponding to a present-row pixels and a next-row pixels on a present data line in a present frame obtained from the display panel, so as to obtain the grayscale change value;
Step S3 includes:
S31: determining, based on the grayscale change value, the resistance value of the traces on the glass substrate, and a first lookup table, whether to perform grading adjustment on the data voltage corresponding to the next-row pixels of the present data line;
Step S4 includes:
S41: adjusting, according to the first lookup table, the grayscale values corresponding to the next-row pixels of the present data line by grading; generating, according to the grayscale values, graded data voltages when the voltage change is greater than or equal to a predetermined value; inputting the graded data voltages to the next-row pixels of the present data line respectively to drive the display panel; and outputting the data voltage corresponding to the next-row pixels of the present data line to drive the display panel when the voltage change value is less than the preset value.

In the present embodiment, taking the change of data voltages of two adjacent pixels on one data line as an example for illustration. Within the present frame, calculating a difference between grayscale values of the data voltages corresponding to a present-row pixels and a next-row pixels on a present data line in a present frame obtained from the display panel, so as to obtain the grayscale change value. Whether grayscale adjustment of the data voltage is required is determined according to the grayscale change value. When the grayscale change value is greater than or equal to the preset value, the grayscale values corresponding to the next-row pixels of the present data line are graded and adjusted according to the first lookup table. Graded data voltages are generated based on the grayscale values and respectively input to the next-row pixels of the present data line for driving. When the grayscale change value is less than the preset value, the data voltage corresponding to the next-row pixels of the present data line is directly output to the data line for driving, the preset value may be set as needed. For example, if the difference between grayscale values is 30 grayscale, the fluctuation of the power supply voltage has little impact on the gamma voltage level and does not affect the display effect. However, when the difference between grayscale values exceeds 30 grayscale, the impact is more obvious. Then the preset value may be set at 30 grayscale. Of course, it may also be selected according to the specific display effect. Different sized display panels or different type display panels may test their respective preset values through the magnitude of abnormal changes during display, and store the preset values in the timing control board.

The grayscale change value is the absolute value of the difference between the previous and subsequent grayscale values. The data voltage is gradually reduced from high to low when the previous grayscale value is greater than the subsequent grayscale value. The data voltage is gradually increased from low to high when the previous grayscale value is less than the subsequent grayscale value. For example, when the load is small, the grayscale voltage is 100 grayscale. If it needs to be switched to 200 grayscale voltage, the instantaneous current is relatively large. During normal charging, from 100 grayscale to 200 grayscale, after the TFT corresponding to the pixel is turned on, the data voltage is directly given as 200 grayscale voltage. Such a large difference exists. Our solution is that within the effective charging period (when the charging period is sufficient), the data voltage is given in stages. As shown in FIG. 4, within the effective charging period, the current rises slowly and finally reaches the target voltage level. Therefore, the voltage V₂ by which VAA is pulled will be significantly improved compared to V₁, being smaller and more gentle, and the peak voltage of VGND) will also be reduced accordingly.

In addition, the number of adjustment levels during graded adjustment is also different when the resistances on the glass substrate, the glass substrates are also known as PCB board. The corresponding resistances of the PCB and the grayscale change values may form a lookup table. When adjustment is required, whether to perform specific graded adjustment on the data voltage corresponding to the next-row pixels of the present data line is determined through the grayscale change value, the resistance value of the traces on the glass substrate, and the first lookup table.

The first lookup tables are set according to the average resistances of the traces on the glass substrate; when the average resistance equals R1, no graded adjustment is performed if the grayscale change value is less than a first preset grayscale value; two-grade adjustment is applied if the grayscale change value is greater than the first preset grayscale value but less than or equal to twice the first preset grayscale value; three-grade adjustment is applied if the grayscale change value is greater than twice the first preset grayscale value but less than three times the first preset grayscale value, with analogous progression for higher multiples.

Specifically, taking the average resistance equals R1 and the first preset grayscale value equals 50 grayscale for illustrative purposes, the first lookup table mainly includes grayscale difference values and grading rules, as shown in Table 1 below:

TABLE 1
First Lookup Table

| Grayscale Difference | Compensation Value |
|---|---|
| Less than 50 grayscale | no graded adjustment |

| | | |
|---|---|---|
| 51-100 | grayscale | two-grade adjustment |
| 101-150 | grayscale | three-grade adjustment |
| 151-200 | grayscale | four-grade adjustment |
| 201-250 | grayscale | five-grade adjustment |

When the average resistance equals R2, if the grayscale change value is less than a second preset grayscale value, no graded adjustment is performed; if the grayscale change value is less than a second preset grayscale value; two-grade adjustment is applied if the grayscale change value is greater than the second preset grayscale value but less than or equal to twice the second preset grayscale value; three-grade adjustment is applied if the grayscale change value is greater than twice the second preset grayscale value but less than three times the second preset grayscale value, with analogous progression for higher multiples. R1 equals any resistance value within the first resistance range, R2 equals any resistance value within the second resistance range where R2 is 1.5 to 2.5 times R1, and the first preset grayscale value is 1.25 to 1.5 times the second preset grayscale value. Resistances of different PCBs vary. Different preset values and different graded adjustment strategies are set according to the respective resistances.

In addition, display panels of different sizes have different loadings, that is, different current draw values. For a 23.8 inch display panel, at the initial stage of display panel design, the resistance value of the entire display panel may be simulated by software. This simulated value is not much different from the actual value after the display panel is produced. Therefore, after knowing the loading size of the display panel at the initial design stage, the benchmark rules to be used may be determined by evaluating the size of resistance value of the display panel. For example, if the loading size of the display panel is 1 to 1.5 times that of the benchmark display panel, we still perform graded voltage boosting according to the benchmark table. If it is 1.5 to 2.5 times the grading in the table is halved. That is, no graded adjustment is performed if the grayscale change value is 0 grayscale to 25 grayscale, two-grade adjustment if the grayscale change value is 25 grayscale to 50 grayscale, three-grade adjustment if the grayscale change value is 50 grayscale to 75 grayscale, with analogous progression for higher multiples. In this way, different voltage-boosting methods may be implemented according to different loadings of display panels.

It should also be noted that when the voltage is adjusted in grades, the voltage in the previous levels rises slowly, which will have a certain impact on the charging of pixels. For example, previously, the grayscale changed directly from 100 grayscale to 200 grayscale, and after reaching 200 grayscale, a charging period of 0.2 s was required to ensure pixel display. But now, results in insufficient charging, because the data voltage changes from 100 grayscale to 150 grayscale first, and then from 150 grayscale to 200 grayscale. Therefore, in order to meet the charging capacity of the pixels while keeping the charging period unchanged, the voltage needs to be adjusted to a value greater than 200 grayscale. When the first preset grayscale value is 50 grayscale and the data voltage of the pixel to be adjusted is greater than that of the previous pixel, if the grayscale change value is 255 grayscale, the voltage is boosted and adjusted in six levels, and the data voltage of the last level is greater than the data voltage corresponding to 255 grayscale. After the adjustment, the data voltage of the last level is continuously input to the pixel to be adjusted for charging, so as to avoid insufficient pixel charging and its impact on display.

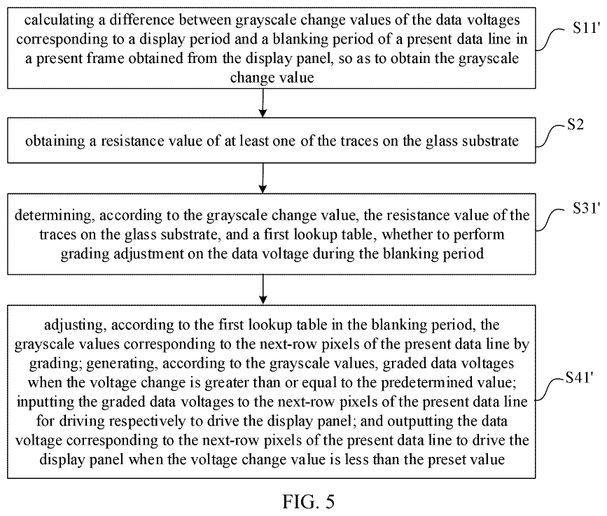

As shown in FIG. 5, as a third embodiment of the present application, different from the second embodiment described above, step S1 includes:
S11′: calculating a difference between grayscale change values of the data voltages corresponding to a display period and a blanking period of a present data line in a present frame obtained from the display panel, so as to obtain the grayscale change value;
Step S3 includes:
S31′: determining, according to the grayscale change value, the resistance value of the traces on the glass substrate, and a first lookup table, whether to perform grading adjustment on the data voltage during the blanking period;
Step S4 includes:
S41′: adjusting, according to the first lookup table in the blanking period, the grayscale values corresponding to the next-row pixels of the present data line by grading; generating, according to the grayscale values, graded data voltages when the voltage change is greater than or equal to the predetermined value; inputting the graded data voltages to the next-row pixels of the present data line for driving respectively to drive the display panel; and outputting the data voltage corresponding to the next-row pixels of the present data line to drive the display panel when the voltage change value is less than the preset value;

The data voltage corresponding to the display period is the data voltage corresponding to the scanned pixels in a last row.

In the present embodiment, it mainly aims at the problem that the conversion between the display period and the blanking period is likely to cause excessive load changes, resulting in power supply voltage fluctuations. By calculating a difference between grayscale values of the data voltages corresponding to a display period and a blanking period on a present data line in a present frame obtained from the display panel, so as to obtain the grayscale change value. Then, the data voltage on the data line is subjected to corresponding graded adjustment according to the grayscale change value. The rules for graded adjustment may be adjusted according to the first lookup table in the second embodiment. As for the specific adjustment magnitude of each level, the difference may be adjusted after being calculated as an average. For example, if the grayscale difference is 100 grayscale, the first level may be adjusted by 50 grayscale, and the second level may be adjusted by another 50 grayscale. Of course, the data voltages are also possible not to adjust according to the average value. The data voltages may be adjusted by 60 grayscale and then adjusted by 40 grayscale.

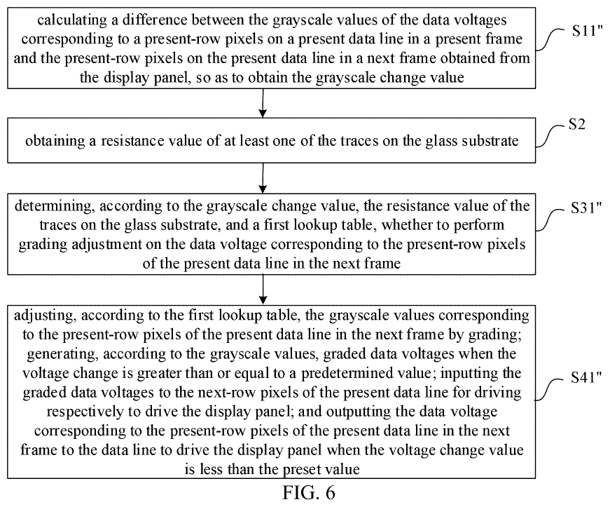

As shown in FIG. 6, as a fourth embodiment of the present application, different from the second embodiment described above, step S1 includes:
S11″: calculating a difference between the grayscale values of the data voltages corresponding to a present-row pixels on a present data line in a present frame and the present-row pixels on the present data line in a next frame obtained from the display panel, so as to obtain the grayscale change value;
Step S3 includes:
S31″: determining, according to the grayscale change value, the resistance value of the traces on the glass substrate, and a first lookup table, whether to perform grading adjustment on the data voltage corresponding to the present-row pixels of the present data line in the next frame;
Step S4 includes:
S41″: adjusting, according to the first lookup table, the grayscale values corresponding to the present-row pixels of the present data line in the next frame by grading; generating, according to the grayscale values, graded data voltages when the voltage change is greater than or equal to a predetermined value; inputting the graded data voltages to the next-row pixels of the present data line for driving respectively to drive the display panel; and outputting the data voltage corresponding to the present-row pixels of the present data line in the next frame to the data line to drive the display panel when the voltage change value is less than the preset value.

In the present embodiment, it mainly addresses the impact caused by excessive load changes when the same pixel switches between consecutive frames. By obtaining the grayscale values of the data voltages corresponding to the current-row pixels on the present data line in the present frame and the present-row pixels on the present data line in the next frame within the display panel, and calculating the difference, the grayscale change value is obtained. Then, the magnitude of the graded adjustment of the data voltage is adjusted according to the grayscale change value. Referring to Table 1 above, for example, if the grayscale difference is within 100 grayscale, it may be adjusted in two levels. For instance, if the grayscale value of the data voltage corresponding to the present-row pixels on the present data line in the present frame within the display panel is 0 grayscale, and the grayscale value of the data voltage corresponding to the present-row pixels on the present data line in the next frame is 90 grayscale, then during graded adjustment, it may be adjusted to 45 grayscale first, and then to 90 grayscale. Of course, the data voltages may also be adjusted to 50 grayscale first and then to 90 grayscale. The graded adjustment may be balanced as above, or the data voltages may be adjusted more in the first stage and less in the second stage, such as 50 grayscale in the first level and 40 grayscale in the second level. In addition, usually to avoid insufficient pixel charging, the data voltages are also possible to directly adjust to 95 grayscale or 100 grayscale in the second level adjustment.

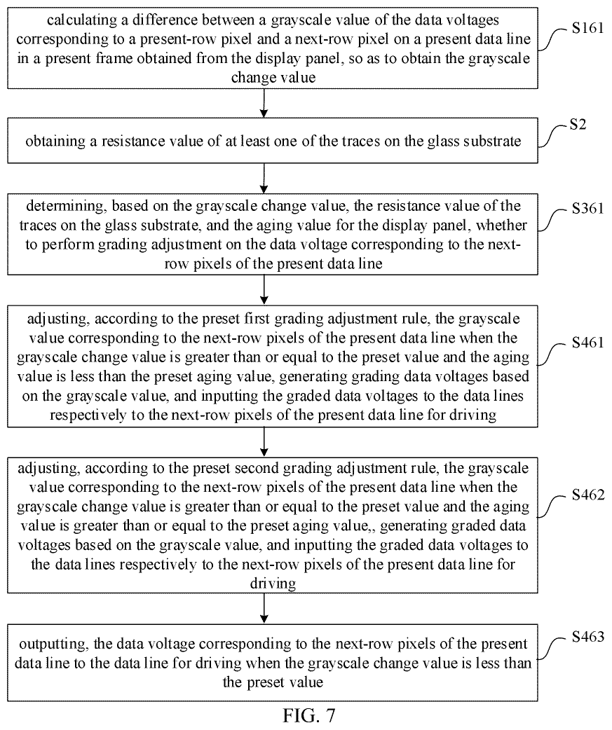

As shown in FIG. 7, as a fifth embodiment of the present application, it is also a further refinement and improvement of the above mentioned first embodiment or the second embodiment. The display device includes an aging test module. The aging test module tests the aging degree of the display panel and provides an aging value for the display panel. The voltage change value includes a grayscale change value, step S1 includes:
S161: calculating a difference between a grayscale value of the data voltages corresponding to a present-row pixel and a next-row pixel on a present data line in a present frame obtained from the display panel, so as to obtain the grayscale change value;
Step S3 includes:
S361: determining, based on the grayscale change value, the resistance value of the traces on the glass substrate, and the aging value for the display panel, whether to perform grading adjustment on the data voltage corresponding to the next-row pixels of the present data line;
Step S4 includes:
S461: adjusting, according to the preset first grading adjustment rule, the grayscale value corresponding to the next-row pixels of the present data line when the grayscale change value is greater than or equal to the preset value and the aging value is less than the preset aging value, generating grading data voltages based on the grayscale value, and inputting the graded data voltages to the data lines respectively to the next-row pixels of the present data line for driving;
S462: adjusting, according to the preset second grading adjustment rule, the grayscale value corresponding to the next-row pixels of the present data line when the grayscale change value is greater than or equal to the preset value and the aging value is greater than or equal to the preset aging value, generating graded data voltages based on the grayscale value, and inputting the graded data voltages to the data lines respectively to the next-row pixels of the present data line for driving; and
S463: outputting, the data voltage corresponding to the next-row pixels of the present data line to the data line for driving when the grayscale change value is less than the preset value.

In the present embodiment, the aging test module is used to test the degree of aging of the display panel and give the aging value of the display panel. Based on both the aging value and the grayscale change value, decisions are made on the graded adjustment of the data lines with significant load changes.

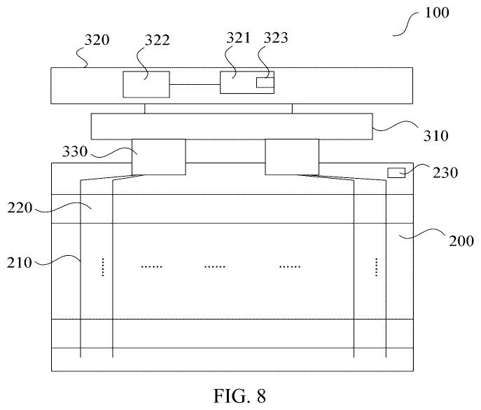

As shown in FIG. 8, as a sixth embodiment of the present application, a display device 100 is disclosed, the display device 100 includes a display panel 200 and a driving module 300, the driving module 300 includes a timing control board 320 and a glass substrate 310, the timing control board 320 outputs a driving signal and a power supply signal to traces on the glass substrate 310 for transmission to the display panel 200. The display device 100 further includes a source driver chip 330, the timing control board 320 includes a memory 321 and a logic judgment module 322, the memory 321 stores the resistance value of the traces on the glass substrate 310 and data information, the logic judgment module 322 determines, based on the resistance value of the traces on the glass substrate 310 and the data information, whether to perform grading adjustment on the target data voltage pre-input to the data line 210. The source driver chip 330 generates, according to the judgment result of the logic judgment module 322, the corresponding data voltage, and outputs the corresponding data voltage to the data line 210 of the display panel 200 for driving.

In the present embodiment, the glass substrate 310 is used as the circuit board for laying traces. Based on the voltage change value of the data line 210 and the resistance value of the traces on the glass substrate 310, the data voltage pre-input to the data line 210 is graded and adjusted. When the voltage change value is greater than or equal to the preset value, the data voltage on the data line 210 is graded and adjusted according to the preset grading rules. Graded data voltages are generated and respectively input to the data line 210 for driving. When the voltage change value is less than the preset value, the target data voltage pre-input to the data line 210 is directly output to the data line 210 for driving according to the original rules. This avoids a situation where a large pressure difference before and after the data line 210 leads to severe current draw, thereby affecting the power supply voltage and causing abnormal gamma voltage levels. Moreover, without the need to additionally set up a current changing circuit or a voltage changing circuit to adjust the power supply voltage, the problem of instantaneous current draw of each voltage source may be compensated. Thus, the problem of large instantaneous current draw during light to heavy load switching is solved, and the stability of the power supply and GND is maintained. Also, this avoids abnormal gamma voltage levels caused by excessive fluctuations in the power supply current and voltage.

Furthermore, a first lookup table 323 is stored in the memory 321. The logic judgment module 322 determines, according to the grayscale change value, the resistance value of the traces on the glass substrate 310, and the first lookup table 323, whether to perform graded adjustment on the data voltage corresponding to the next-row pixels of the present data line 210, so as to control the source driver chip 330 to generate a corresponding data voltage and output the corresponding data voltage to the data line 210 of the display panel 200 for driving. A plurality of first lookup tables are provided, each of the plurality of first lookup tables being configured based on an average resistance of the traces on the glass substrate 310. Of course, the first lookup may also be set according to the trace with the maximum resistance among all the traces on the glass substrate 310.

In addition, the display device 100 includes an aging test module 230. The aging test module 230 tests the degree of aging of the display panel 200 and gives the aging value of the display panel 200. By using the aging test module 230 to test the degree of aging of the display panel 200 and obtain the aging value of the display panel 200, decisions on the graded adjustment of the data line 210 with significant load changes are made based on both the aging value and the grayscale change value.

It should be noted that the limitations of the various operations involved in this solution are not to be interpreted to limit the order of the operations, under the premise of not affecting the implementation of the specific solution. The operations written earlier may be executed first, or later, or even at the same time as the operations written later. As long as this solution may be implemented, it should be regarded as falling within the scope of protection of the present application.

It should be noted that the inventive concept of the present application may be formed into many embodiments, but the length of the application document is limited and so these embodiments cannot be enumerated one by one. Therefore, should no conflict be present, the various embodiments or technical features described above may be arbitrarily combined to form new embodiments. After the various embodiments or technical features are combined, the original technical effects may be enhanced.

The foregoing is a further detailed description of the present application with reference to some specific optional implementations, but it cannot be determined that the specific implementation of the present application is limited to these implementations. For those having ordinary skill in the technical field to which the present application pertains, several deductions or substitutions may be made without departing from the concept of the present application, and all these deductions or substitutions should be regarded as falling within the scope of protection of the present application.

What is claimed is:

1. A driving method of a display device, the display device comprising a display panel and a driving module, wherein the driving module comprises a timing control board and a glass substrate, the timing control board generates a driving signal and a power supply signal, the driving signal and the power supply signal are respectively output to the display panel through different traces of the glass substrate; wherein the driving method comprises:
predicting a voltage change value of a data line inside the display panel;
obtaining a resistance value of at least one of the traces on the glass substrate;
determining, based on the voltage change value and the resistance value, whether to perform grading adjustment on a target data voltage pre-input to the data line; and
adjusting, according to predetermined grading rules, a data voltage on the data line by grading when the voltage change is greater than or equal to a predetermined value, generating graded data voltages, and inputting the graded data voltages to the data lines respectively to drive the display panel; outputting, according to original rules, the target data voltage pre-input directly to the data line to drive the display panel when the voltage change value is less than the preset value.

2. The driving method according to claim 1, wherein the voltage change value comprises a grayscale change value, wherein the predicting the voltage change value of the data line inside the display panel comprises:
calculating a difference between grayscale values of the data voltages corresponding to a present-row pixels and a next-row pixels on a present data line in a present frame obtained from the display panel, so as to obtain the grayscale change value;
wherein the determining, based on the voltage change value and the resistance value, whether to perform grading adjustment on a target data voltage pre-input to the data line comprises:
determining, based on the grayscale change value, the resistance value of the traces on the glass substrate, and a first lookup table, whether to perform grading adjustment on the data voltage corresponding to the next-row pixels of the present data line;
wherein the adjusting, according to predetermined grading rules, a data voltage on the data line by grading when the voltage change is greater than or equal to a predetermined value, generating graded data voltages, and inputting the graded data voltages to the data lines respectively to drive the display panel; outputting, according to original rules, the target data voltage pre-input directly to the data line to drive the display panel when the voltage change value is less than the preset value comprises:
adjusting, according to the first lookup table, the grayscale values corresponding to the next-row pixels of the present data line by grading;
generating, according to the grayscale values, graded data voltages when the voltage change is greater than or equal to a predetermined value;
inputting the graded data voltages to the next-row pixels of the present data line respectively to drive the display panel; and
outputting the data voltage corresponding to the next-row pixels of the present data line to drive the display panel when the voltage change value is less than the preset value.

3. The driving method according to claim 1, wherein the voltage change value comprises a grayscale change value, wherein the predicting the voltage change value of the data line inside the display panel comprises:
calculating a difference between grayscale values of the data voltages corresponding to a display period and a blanking period on a present data line in a present frame obtained from the display panel, so as to obtain the grayscale change value;
wherein the determining, based on the voltage change value and the resistance value, whether to perform grading adjustment on a target data voltage pre-input to the data line comprises:
determining, according to the grayscale change value, the resistance value of the traces on the glass substrate, and a first lookup table, whether to perform grading adjustment on the data voltage during the blanking period;
wherein the adjusting, according to predetermined grading rules, a data voltage on the data line by grading when the voltage change is greater than or equal to a predetermined value, generating graded data voltages, and inputting the graded data voltages to the data lines respectively to drive the display panel; outputting, according to original rules, the target data voltage pre-input directly to the data line to drive the display panel when the voltage change value is less than the preset value comprises:
adjusting, according to the first lookup table in the blanking period, the grayscale values corresponding to the next-row pixels of the present data line by grading;
generating, according to the grayscale values, graded data voltages when the voltage change is greater than or equal to the predetermined value;
inputting the graded data voltages to the next-row pixels of the present data line for driving respectively to drive the display panel; and
outputting the data voltage corresponding to the next-row pixels of the present data line to drive the display panel when the voltage change value is less than the preset value;
wherein the data voltage corresponding to the display period is the data voltage corresponding to the scanned pixels in a last row.

4. The driving method according to claim 1, wherein the voltage change value comprises a grayscale change value, wherein the predicting the voltage change value of the data line inside the display panel comprises:
calculating a difference between the grayscale values of the data voltages corresponding to a present-row pixels on a present data line in a present frame and the present-row pixels on the present data line in a next frame obtained from the display panel, so as to obtain the grayscale change value;
wherein the determining, based on the voltage change value and the resistance value, whether to perform grading adjustment on a target data voltage pre-input to the data line comprises:
determining, according to the grayscale change value, the resistance value of the traces on the glass substrate, and a first lookup table, whether to perform grading adjustment on the data voltage corresponding to the present-row pixels of the present data line in the next frame;
wherein the adjusting, according to predetermined grading rules, a data voltage on the data line by grading when the voltage change is greater than or equal to a predetermined value, generating graded data voltages, and inputting the graded data voltages to the data lines respectively to drive the display panel; outputting, according to original rules, the target data voltage pre-input directly to the data line to drive the display panel when the voltage change value is less than the preset value comprises:
adjusting, according to the first lookup table, the grayscale values corresponding to the present-row pixels of the present data line in the next frame by grading;
generating, according to the grayscale values, graded data voltages when the voltage change is greater than or equal to a predetermined value;
inputting the graded data voltages to the next-row pixels of the present data line for driving respectively to drive the display panel; and
outputting the data voltage corresponding to the present-row pixels of the present data line in the next frame to the data line to drive the display panel when the voltage change value is less than the preset value.

5. The driving method according to claim 2, wherein a plurality of first lookup tables are provided, each of the plurality of first lookup tables being configured based on an average resistance of the traces on the glass substrate;
when the average resistance equals R1:
no graded adjustment is performed if the grayscale change value is less than a first preset grayscale value;
two-grade adjustment is applied if the grayscale change value is greater than the first preset grayscale value but less than or equal to twice the first preset grayscale value;
three-grade adjustment is applied if the grayscale change value is greater than twice the first preset grayscale value but less than three times the first preset grayscale value, with analogous progression for higher multiples;
when the average resistance equals R2:
no graded adjustment is performed if the grayscale change value is less than a second preset grayscale value;
two-grade adjustment is applied if the grayscale change value is greater than the second preset grayscale value but less than or equal to twice the second preset grayscale value;
three-grade adjustment is applied if the grayscale change value is greater than twice the second preset grayscale value but less than three times the second preset grayscale value, with analogous progression for higher multiples;
wherein R1 equals any resistance value within a first resistance range, R2 is any resistance value within a second resistance range where R2 is 1.5 to 2.5 times R1, and the first preset grayscale value is 1.25 to 1.5 times the second preset grayscale value.

6. The driving method according to claim 3, wherein a plurality of first lookup tables are provided, each of the plurality of first lookup tables being configured based on an average resistance of the traces on the glass substrate;
when the average resistance equals R1:
no graded adjustment is performed if the grayscale change value is less than a first preset grayscale value;
two-grade adjustment is applied if the grayscale change value is greater than the first preset grayscale value but less than or equal to twice the first preset grayscale value;
three-grade adjustment is applied if the grayscale change value is greater than twice the first preset grayscale value but less than three times the first preset grayscale value, with analogous progression for higher multiples;
when the average resistance equals R2:
no graded adjustment is performed if the grayscale change value is less than a second preset grayscale value;
two-grade adjustment is applied if the grayscale change value is greater than the second preset grayscale value but less than or equal to twice the second preset grayscale value;
three-grade adjustment is applied if the grayscale change value is greater than twice the second preset grayscale value but less than three times the second preset grayscale value, with analogous progression for higher multiples;
wherein R1 equals any resistance value within a first resistance range, R2 is any resistance value within a second resistance range where R2 is 1.5 to 2.5 times R1, and the first preset grayscale value is 1.25 to 1.5 times the second preset grayscale value.

7. The driving method according to claim 4, wherein a plurality of first lookup tables are provided, each of the plurality of first lookup tables being configured based on an average resistance of the traces on the glass substrate;
when the average resistance equals R1:
no graded adjustment is performed if the grayscale change value is less than a first preset grayscale value;
two-grade adjustment is applied if the grayscale change value is greater than the first preset grayscale value but less than or equal to twice the first preset grayscale value;
three-grade adjustment is applied if the grayscale change value is greater than twice the first preset grayscale value but less than three times the first preset grayscale value, with analogous progression for higher multiples;
when the average resistance equals R2:
no graded adjustment is performed if the grayscale change value is less than a second preset grayscale value;
two-grade adjustment is applied if the grayscale change value is greater than the second preset grayscale value but less than or equal to twice the second preset grayscale value;
three-grade adjustment is applied if the grayscale change value is greater than twice the second preset grayscale value but less than three times the second preset grayscale value, with analogous progression for higher multiples;
wherein R1 equals any resistance value within a first resistance range, R2 is any resistance value within a second resistance range where R2 is 1.5 to 2.5 times R1, and the first preset grayscale value is 1.25 to 1.5 times the second preset grayscale value.

8. The driving method according to claim 2, wherein a charging period corresponding to the pixel awaiting adjusted data voltage comprises a first charging period and a second charging period when the grayscale change value is greater than or equal to a preset value, the data voltage on the data line gradedly ascends from a first data voltage used for charging a previous pixel to a second data voltage during the first charging period; the second data voltage is continuously output from the data line to the pixel awaiting adjusted data voltage during the second charging period;
wherein a ratio of a duration of the first charging period to a duration of the second charging period is less than or equal to ⅕, and the duration of the first charging period is set according to a peak moment of an analog voltage of the power supply signal.

9. The driving method according to claim 3, wherein a charging period corresponding to the pixel awaiting adjusted data voltage comprises a first charging period and a second charging period when the grayscale change value is greater than or equal to a preset value, the data voltage on the data line gradedly ascends from a first data voltage used for charging a previous pixel to a second data voltage during the first charging period; the second data voltage is continuously output from the data line to the pixel awaiting adjusted data voltage during the second charging period;
wherein a ratio of a duration of the first charging period to a duration of the second charging period is less than or equal to ⅕, and the duration of the first charging period is set according to a peak moment of an analog voltage of the power supply signal.

10. The driving method according to claim 4, wherein a charging period corresponding to the pixel awaiting adjusted data voltage comprises a first charging period and a second charging period when the grayscale change value is greater than or equal to a preset value, the data voltage on the data line gradedly ascends from a first data voltage used for charging a previous pixel to a second data voltage during the first charging period; the second data voltage is continuously output from the data line to the pixel awaiting adjusted data voltage during the second charging period;
wherein a ratio of a duration of the first charging period to a duration of the second charging period is less than or equal to ⅕, and the duration of the first charging period is set according to a peak moment of an analog voltage of the power supply signal.

11. The driving method according to claim 5, wherein the first preset grayscale value is 50, a six-grade boosting adjustment is performed when the data voltage of the pixel to be adjusted is greater than that of a previous pixel and a grayscale variation value is 255, and the data voltage of a final grade is greater than the data voltage corresponding to 255 grayscale levels, after the adjustment is completed, the data voltage of the final grade is continuously input to the pixel to be adjusted for charging.

12. The driving method according to claim 6, wherein the first preset grayscale value is 50, a six-grade boosting adjustment is performed when the data voltage of the pixel to be adjusted is greater than that of a previous pixel and a grayscale variation value is 255, and the data voltage of a final grade is greater than the data voltage corresponding to 255 grayscale levels, after the adjustment is completed, the data voltage of the final grade is continuously input to the pixel to be adjusted for charging.

13. The driving method according to claim 7, wherein the first preset grayscale value is 50, a six-grade boosting adjustment is performed when the data voltage of the pixel to be adjusted is greater than that of a previous pixel and a grayscale variation value is 255, and the data voltage of a final grade is greater than the data voltage corresponding to 255 grayscale levels, after the adjustment is completed, the data voltage of the final grade is continuously input to the pixel to be adjusted for charging.

14. The driving method according to claim 1, wherein the display device comprises an aging test module, the aging test module tests an aging degree of the display panel and provides an aging value for the display panel; the voltage change value comprises a grayscale change value, wherein the predicting the voltage change value of the data line inside the display panel comprises:
calculating a difference between grayscale values of the data voltages corresponding to a present-row pixel and a next-row pixel on a present data line in a present frame obtained from the display panel, so as to obtain the grayscale change value;
wherein the determining, based on the voltage change value and the resistance value, whether to perform grading adjustment on a target data voltage pre-input to the data line comprises:
determining, based on the grayscale change value, the resistance value of the traces on the glass substrate, and the aging value for the display panel, whether to perform grading adjustment on the data voltage corresponding to the next-row pixels of the present data line;
wherein the adjusting, according to predetermined grading rules, a data voltage on the data line by grading when the voltage change is greater than or equal to a predetermined value, generating graded data voltages, and inputting the graded data voltages to the data lines respectively to drive the display panel; outputting, according to original rules, the target data voltage pre-input directly to the data line to drive the display panel when the voltage change value is less than the preset value comprises:
adjusting, according to the preset first grading adjustment rule, the grayscale value corresponding to the next-row pixels of the present data line when the grayscale change value is greater than or equal to the preset value and the aging value is less than the preset aging value, generating grading data voltages based on the grayscale value, and inputting the graded data voltages to the data lines respectively to the next-row pixels of the present data line for driving;
adjusting, according to the preset second grading adjustment rule, the grayscale value corresponding to the next-row pixels of the present data line when the grayscale change value is greater than or equal to the preset value and the aging value is greater than or equal to the preset aging value, generating graded data voltages based on the grayscale value, and inputting the graded data voltages to the data lines respectively to the next-row pixels of the present data line for driving;
outputting, the data voltage corresponding to the next-row pixels of the present data line to the data line for driving when the grayscale change value is less than the preset value.

15. The driving method according to claim 2, wherein the grayscale change value is an absolute difference between a prior gray level value and a subsequent gray level value, the data voltage gradedly decreases from high to low in stages when the prior grayscale value is greater than the subsequent grayscale value, and the data voltage gradedly incremental from low to high in stages when the previous grayscale value is less than the subsequent grayscale value.

16. The driving method according to claim 3, wherein a grayscale value adjusted per grade is an average value obtained by averaging differences between the grayscale values of the data voltages corresponding to the display period and the blanking period of the present data line in the display panel within the present frame.

17. A display device, wherein the display device comprises a display panel and a driving module, wherein the driving module comprises a timing control board and a glass substrate, the timing control board outputs a driving signal and a power supply signal to traces on the glass substrate for transmission to the display panel; the display device further comprises a source driver chip, the timing control board comprises a memory and a logic judgment module, the memory stores the resistance value of the traces on the glass substrate and data information, the logic judgment module determines, based on the resistance value of the traces on the glass substrate and the data information, whether to perform grading adjustment on the target data voltage pre-input to the data line, the source driver chip according to the judgment result of the logic judgment module, generates a corresponding data voltage, and outputs the corresponding data voltage to the data line of the display panel for driving;
wherein the display device is driven by a driving method described as follows, the driving method comprises:
predicting a voltage change value of a data line inside the display panel;
obtaining a resistance value of at least one of the traces on the glass substrate;
determining, based on the voltage change value and the resistance value, whether to perform grading adjustment on a target data voltage pre-input to the data line; and
adjusting, according to predetermined grading rules, a data voltage on the data line by grading when the voltage change is greater than or equal to a predetermined value, generating graded data voltages, and inputting the graded data voltages to the data lines respectively to drive the display panel; outputting, according to original rules, the target data voltage pre-input directly to the data line to drive the display panel when the voltage change value is less than the preset value.

18. The display device according to claim 17, wherein the memory stores a first lookup table, the logic judgment module determines, according to the grayscale change value, the resistance value of the traces on the glass substrate, and the first lookup table, whether to perform grading adjustment on the data voltage corresponding to the next-row pixels of the present data line, so as to control the source driver chip to generate a corresponding data voltage, and outputs the corresponding data voltage to the data line of the display panel for driving.

19. The display device according to claim 17, wherein the display device comprises an aging test module, the aging test module tests an aging degree of the display panel and provides an aging value for the display panel;
adjusting, according to the preset first grading adjustment rule, the grayscale value corresponding to a next-row pixels of a present data line when the grayscale change value is greater than or equal to the preset value and the aging value is less than the preset aging value, generating grading data voltages based on the grayscale value, and inputting the graded data voltages to the data lines respectively to the next-row pixels of the present data line for driving;
adjusting, according to the preset second grading adjustment rule, the grayscale value corresponding to the next-row pixels of the present data line when the grayscale change value is greater than or equal to the preset value and the aging value is greater than or equal to the preset aging value, generating graded data voltages based on the grayscale value, and inputting the graded data voltages to the data lines respectively to the next-row pixels of the present data line for driving;
outputting, the data voltage corresponding to the next-row pixels of the present data line to the data line for driving when the grayscale change value is less than the preset value.
